(19) United States
(12) Patent Application Publication
(10) Pub. No.: US 2011/0039951 A1
(43) Pub. Date: Feb. 17, 2011

(54) WATER CLUSTERS CONFINED IN NANO-ENVIRONMENTS

(75) Inventors: Matthew Price-Gallagher, Montreal (CA); Keith Johnson, Cambridge, MA (US)

Correspondence Address: CHOATE, HALL & STEWART LLP, TWO INTERNATIONAL PLACE, BOSTON, MA, 02110, US

(73) Assignee: HYDRO ELECTRON VENTURES, Montreal (CA)

(21) Appl. No.: 12/727,461

(22) Filed: Mar. 19, 2010

Related U.S. Application Data
(60) Provisional application No. 61/161,927, filed on Mar. 20, 2009.

(51) Int. Cl. C09K 3/00; C01B 5/00; C01B 5/02

(52) U.S. Cl. 516/21; 423/580.1; 423/580.2; 977/742

(57) ABSTRACT

The disclosure describes a method including providing a nano-environment; and confining heavy or light water in the nano-environment such that at least one water cluster forms.

### CROSS-REFERENCE TO RELATED APPLICATIONS

The present application claims priority to U.S. Provisional Patent Application Ser. No. 61/161,927, filed Mar. 20, 2009, the contents of each of which are herein incorporated by reference.

### BACKGROUND OF THE INVENTION

Water covers two-thirds of the globe and constitutes 70 percent of our body weight. Life on Earth would not exist without it. Water vapor in Earth's atmosphere is the most potent greenhouse gas. Small polyhedral clusters of water molecules, such as that shown in FIGS. 1 and 2, have been experimentally identified as being key to the hydration and stabilization of biomolecules, proteins, DNA, and DNA-drug complexes. Such examples indicate the tendency of water pentagons (FIG. 1) to form closed geometrical structures like the pentagonal dodecahedron shown in FIG. 2. It has also been suggested that water clusters may play a fundamental role in determining biological cell architecture. While most of the human body is water by weight, much of that water is believed not to be ordinary bulk liquid, but instead, nanoclustered, “restructured” water which affects biomolecular processes ranging from protein stability to enzyme activity. For example, nanostructured water in the form of water clusters has been found to congregate in the confined cavities of proteins and other biomolecules, where a cluster of water molecules interacts with a protein amino-acid group.

Scientific interest in water clusters has been primarily motivated by their possible roles in atmospheric and environmental phenomena, including global warming, as well as by their relevance to the structure and properties of liquid water and ice. Experiment and theory agree that not only can such clusters be produced, but also they exist optimally in certain “magic numbers” and configurations of water molecules.

### SUMMARY OF THE INVENTION

In various aspects, the present invention provides a method comprising steps of providing a nano-environment and confining water in the nano-environment such that at least one water cluster forms. In some embodiments, the providing step provides a nano-environment that comprises systems in solid, liquid, or gel phases and/in contact with macromolecules. In some embodiments, the providing step provides a nano-environment that comprises a nanotube. In some embodiments, the providing step provides a nano-environment that comprises a nano-layer. In some embodiments, the providing step provides a nano-environment that comprises a carbon nanotube. In some embodiments, the providing step provides a nano-environment that comprises a graphene nano-layer. In some embodiments, the providing step provides a nano-environment that is doped with an electron donating compound. In some embodiments, the providing step provides a nano-environment that is doped with a variety of elements and alloys, with nitrogen, palladium, palladium-gold, palladium-silver. In some embodiments, the water may be heavy water (i.e., D₂O) or ordinary, light water (i.e., H₂O).

In some embodiments, the confining step produces a water cluster that comprises at least one pentagonal water cluster. In some embodiments, the confining step produces a water cluster that comprises at least one pentagonal-dodecahedral water cluster. In some embodiments, the confining step produces a water cluster that comprises at least one water cluster with at least partial pentagonal-dodecahedral symmetry.

In some embodiments, the confining step produces a water cluster that comprises less than about 300 molecules, less than about 100 molecules, or less than about 20 molecules.

In some embodiments, the confining step produces a water cluster that has an average dimension of about less than about 100 nanometers, less than about 50 nanometers, or less than about 10 nanometers.

In some embodiments, the confining step produces a water cluster that has an average dimension in the range of about 0.5 nanometers to about 10 nanometers.

In some embodiments, the confining step produces a water cluster that has molecular vibrations in the frequency range of about 0.1 terahertz to about 32 terahertz.

In some embodiments, the confining step produces a water cluster that has an electronic structure where the cluster LUMOs are “Rydberg” “S”-, “P”-, “D”-, and “F”-like molecular orbitals that accept an extra electron via optical excitation, ionization, or electron-donation from interacting atoms or molecules.

In some embodiments, the confining step produces a water cluster in which its terahertz molecular vibrations couple with its electronic structure to create terahertz vibronic properties.

In some embodiments, the method further includes stimulating the water cluster's terahertz vibronic properties by the dynamic Jahn-Teller effect.

In some embodiments, the method further includes stimulating the water cluster's terahertz vibronic properties by optical excitation, by applying an electromagnetic field, or by applying an electrical charge. In some embodiments, the cluster's terahertz vibronic properties are stimulated by using broadband, high intensity lasers. In some embodiments, the cluster's terahertz vibronic properties are further stimulated by doped electron-donating compounds in the nano-environment.

In some embodiments, the confining step includes a water cluster in an water-in-oil nanoemulsion. In some embodiments, the confining step produces a nanoemulsion further comprises a surfactant. In some embodiments, the confining step produces a nanoemulsion further comprises an electron donating compound.

In some embodiments, the method further includes stimulating the water cluster's terahertz vibronic properties by introducing an electron donating compound.

In various aspects, the present invention includes a composition comprising water confined in a nano-environment such that at least one water cluster forms.

In some embodiments, the nano-environment comprises a nanotube. In some embodiments, the nano-environment comprises systems in solid, liquid, or gel phases and/in contact with macromolecules.

In some embodiments, the nano-environment comprises a nano-layer.

In some embodiments, the nano-environment comprises a carbon nanotube.

In some embodiments, the nano-environment comprises a graphene nano-layer.

In some embodiments, the nano-environment is doped with an electron donating compound.

In some embodiments, the water cluster comprises at least one pentagonal water cluster.

In some embodiments, the water cluster comprises at least one pentagonal-dodecahedral water cluster.

In some embodiments, the water cluster comprises at least one water cluster with at least partial pentagonal-dodecahedral symmetry. In some embodiments, the water cluster comprises less than about 300 molecules, less than about 100 molecules, or less than about 20 molecules. In some embodiments, the water cluster has an average dimension of about less than about 100 nanometers, less than about 50 nanometers, less than about 10 nanometers.

In some embodiments, the water clusters have an average dimension in the range of about 0.5 nanometers to about 10 nanometers.

In some embodiments, the water cluster has molecular vibrations in the frequency of 0.1 terahertz to 32 terahertz.

In some embodiments, the water cluster has an electronic structure where the cluster LUMOs are “Rydberg” “S”-, “P”-, “D”-, and “F”-like molecular orbitals that accept an extra electron via optical excitation, ionization, or electron-donation from interacting atoms or molecules.

In some embodiments, the water cluster's terahertz molecular vibrations couples with its electronic structure to create terahertz vibronic properties. In some embodiments, the water cluster's terahertz vibronic properties are further stimulated by the dynamic Jahn-Teller effect. In some embodiments, the water cluster's terahertz vibronic properties are further stimulated by optical excitation, by applying an electromagnetic field, by applying an electrical charge, or by doped electron-donating compounds in the nano-environment.

In some embodiments, the water cluster is in a water-in-oil nanoemulsion. In some embodiments, the nanoemulsion further comprises a surfactant. In some embodiments, the nanoemulsion further comprises an electron donating compound. In some embodiments, the cluster's terahertz vibronic properties are further stimulated by an electron from an electron donating compound.

### DESCRIPTION OF THE DRAWINGS

FIG. 1 shows an exemplary water pentamer.

FIG. 2 shows an exemplary protonated water cluster.

FIG. 3 shows a water cluster interacting with a protein amino acid group.

FIG. 4 shows pπ orbitals of a water cluster.

FIG. 5 shows pπ orbitals of a water cluster.

FIG. 6 shows the vibrational modes of a pentagonal dodecahedron water cluster.

FIG. 7 shows carbon nanotube confined water clusters.

FIG. 8 shows graphene layer confined water clusters.

FIG. 9 shows a large water cluster.

FIG. 10 shows the density functional molecular orbital energies of the (H₂O)₂₁H⁺ cluster.

FIG. 11 shows the S-, P-, D- and F-like LUMO wavefunctions of the (H₂O)₂₁H⁺ cluster.

FIG. 12 shows complete computed vibrational spectrum of a (H₂O)₂₁H⁺ cluster.

FIG. 13 shows the vectors/vibrational mode of the 1.56 THz squashing mode of a dodecahedral cluster.

### DETAILED DESCRIPTION OF CERTAIN EMBODIMENTS

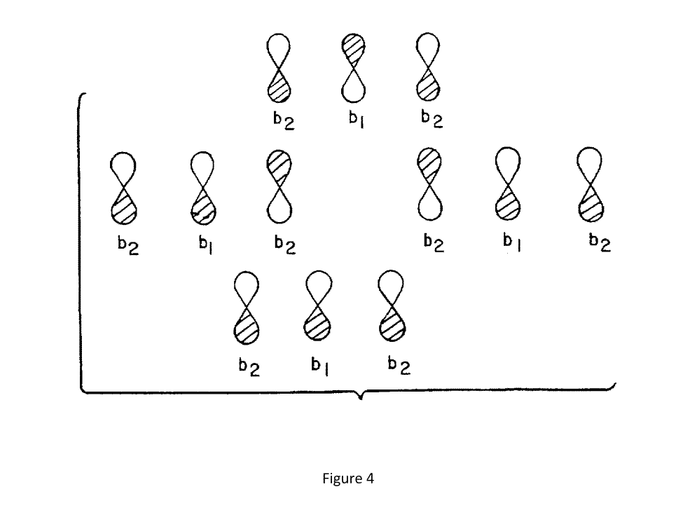

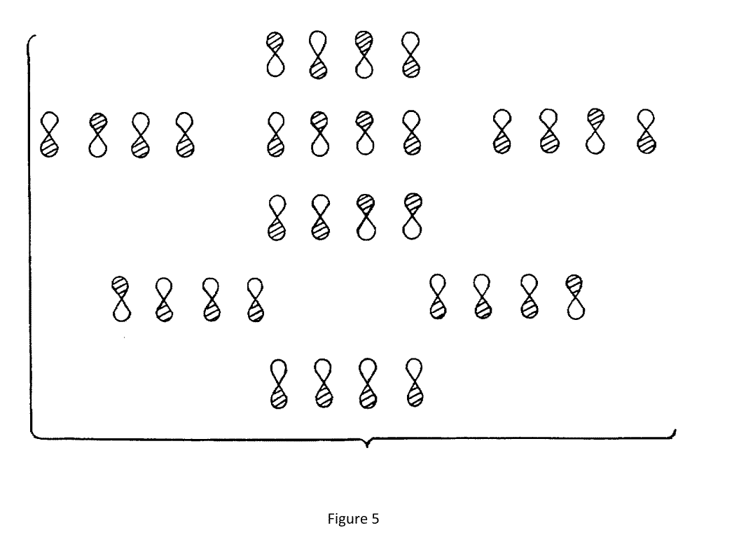

One of ordinary skill in the art will appreciate that interacting molecules form interacting molecular orbitals. For example, several interacting water molecules produce pπ b₁ and 1b₂ orbitals. Those of ordinary skill in the art will further appreciate that the larger the number of water molecules that are interacting with one another, the more different combinations of b₁ and 1b₂ molecular orbitals will be created, each producing a pπ orbital with a particular extent of bonding or antibonding character. For example, FIG. 4 presents possible pπ orbitals produced by combinations of b₁and 1b₂ orbitals on three water molecules; FIG. 5 present possible pπ orbitals produced by combinations of b₁and 1b₂ orbitals on four water molecules. As can be seen, the larger the number of interacting water molecules, the larger the manifold of possible pπ orbitals. One of ordinary skill in the art will recognize that the water may be either heavy water (i.e., D₂O) or ordinary, light water (i.e., H₂O).

It will be appreciated that both the b₁and 1b₂ orbitals in water are occupied. Accordingly, the oxygen-oxygen interactions described by the present invention involve interactions of filled orbitals. Furthermore, the THz vibrations and excited states of the molecules involve interactions of filled and unfilled orbitals. Traditional molecular orbital theory teaches that interactions between such filled orbitals typically do not occur because, due to repulsion between the electron pairs, the antibonding orbitals produced by the interaction are more destabilized than the bonding orbitals are stabilized. However, in the case of interacting oxygen atoms on adjacent water molecules, the interacting atoms are farther apart (about 2.8 Å, on average) than they would be if they were covalently bonded to one another. Thus, the electron-pair repulsion is weaker than it would otherwise be and such asymmetrical orbital splitting is not expected to occur. In fact, some “bonding” and “antibonding” orbital combinations can have substantially identical energies. The highest occupied molecular orbital (HOMO) in water is, therefore, a manifold of substantially degenerate pπ orbitals with varying bonding and antibonding character; the lowest unoccupied molecular orbital (LUMO) in water represents a manifold of states corresponding to interactions involving 2b₂ orbitals an adjacent water molecules.

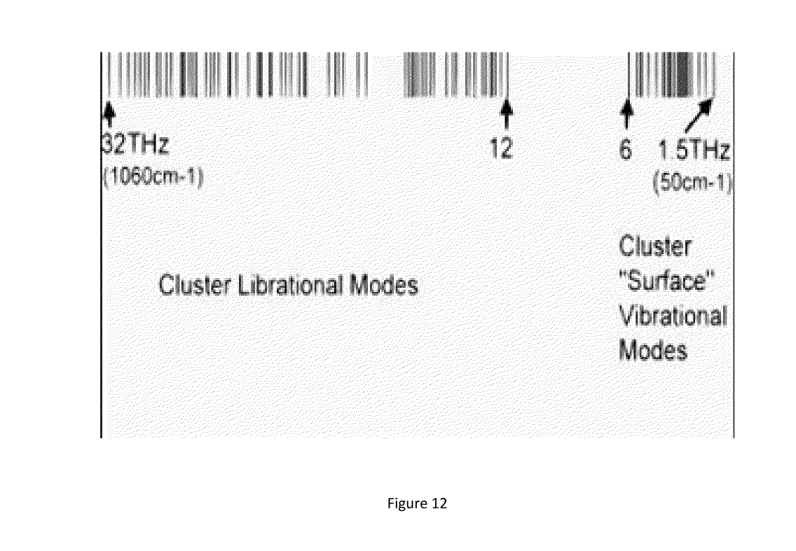

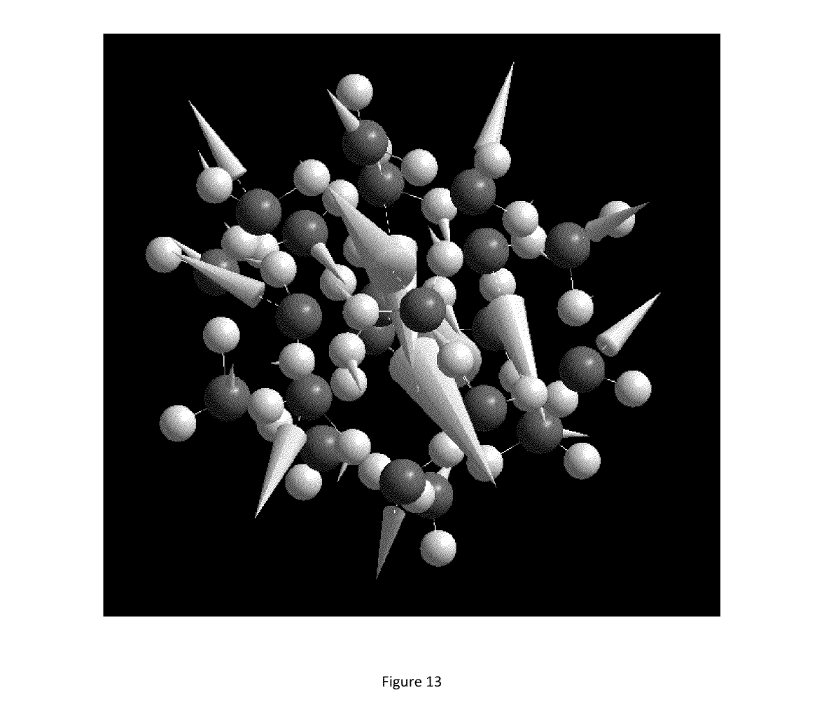

As described above, one aspect of the invention is the discovery that oxygen-oxygen interactions can occur among neighboring water molecules through overlap of b₁ and 1b₂ orbitals on adjacent oxygens that produces degenerate, delocalized pπ orbitals. A further aspect of the invention is the recognition that such pπ orbitals, if made to protrude from the surface of a water structure, can impart high reactivity to oxygens within that structure. The inventors draw an analogy between the presently described water oxygen pπ orbitals and dir orbitals known to impart reactivity to certain chemical catalysts (see, for example Johnson, in The New World of Quantum Chemistry, ed. by Pullman et al., Reidel Publishing Co., Dorderecht-Holland, pp. 317-356, 1976. According to the present invention, water oxygens can be made to catalyze via their 1-6 terahertz (THz) vibronic interactions (see FIG. 12) their own oxidative addition to other molecules by incorporating them into water structures in which pπ orbitals associated with oxygen-oxygen interactions protrude from the structure surface. As shown in FIG. 12, 12-32 THz “librational” modes of the water cluster hydrogen atoms are involved in catalyzing hydrogenation reactions.

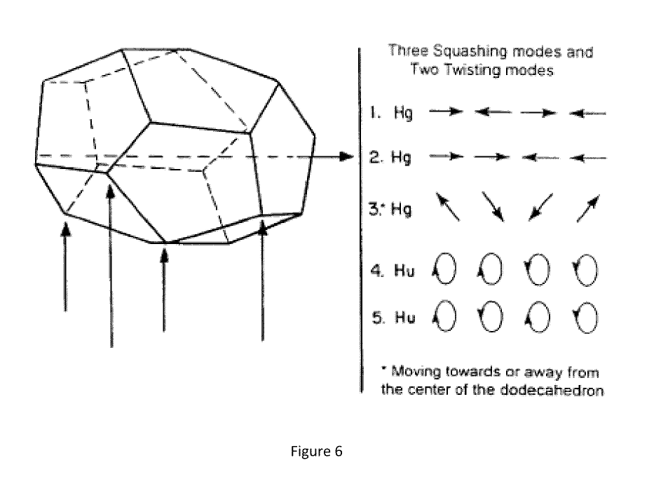

Preferred water clusters of the present invention have symmetry characteristics. Symmetry increases the degeneracy of the pπ orbitals and also produces more delocalized orbitals, thereby increasing the “surface reactivity” of the cluster. Symmetry also allows collective vibration of oxygen-oxygen interactions within the clusters, so that the likelihood that a protruding pπ orbital will have an opportunity to overlap with a potential reactant orbital is increased. In some embodiments, water clusters comprise pentagonal arrays of water molecules, and may comprise pentagonal arrays with maximum icosahedral symmetry. In some embodiments, the water clusters comprise pentagonal dodecahedral arrays of water molecules. Of particular importance are the 1-6 THz “squashing” and “twisting” water-cluster “surface” vibrational modes of the otherwise ideal pentagonal dodecahedral cluster shown in FIGS. 6 and 12.

Water clusters comprising pentagonal arrays of water molecules are preferred at least in part because of their THz vibrational modes that can contribute to enhanced oxygen reactivity are associated with the oxygen-oxygen “squashing” and “twisting” modes (depicted for a pentagonal dodecahedral water structure in FIG. 6). These modes have calculated THz vibrational frequencies that i.e. between the far infrared and microwave regions of the electromagnetic spectrum, within the range of approximately 1-6 THz (33-200 cm⁻¹). Induction of such modes may be accomplished resonantly, for example through application of electrical, electromagnetic, and/or ultrasonic fields, or may be accomplished intrinsically through the dynamical Jahn-Teller (“DJT”) effect. As shown in FIG. 12, 12-32 THz “librational” modes of the water cluster hydrogen atoms are involved in catalyzing hydrogenation chemical/electrochemical reactions, including those involving “heavy hydrogen” (deuterium) if ordinary water is replaced by heavy water.

The DJT effect refers to a symmetry-breaking phenomenon in which molecular vibrations of appropriate frequency couple with certain degenerate energy states available to a molecule, so that those states are split away from the other states with which they used to be degenerate (for review, see Bersuker et al., Vibronic Interactions in Molecules and Crystals, Springer Verlag, NY, 1990). Thus, natural coupling between the oxygen-oxygen vibrations and the degenerate pπ molecular orbitals of water clusters of the present invention can enhance oxygen reactivity.

### Pentagonal Dodecahedral Water Clusters

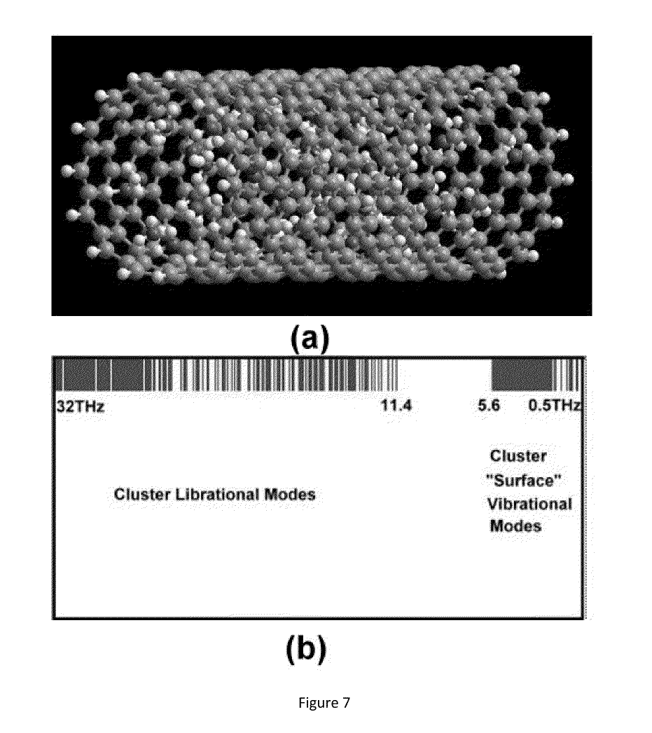

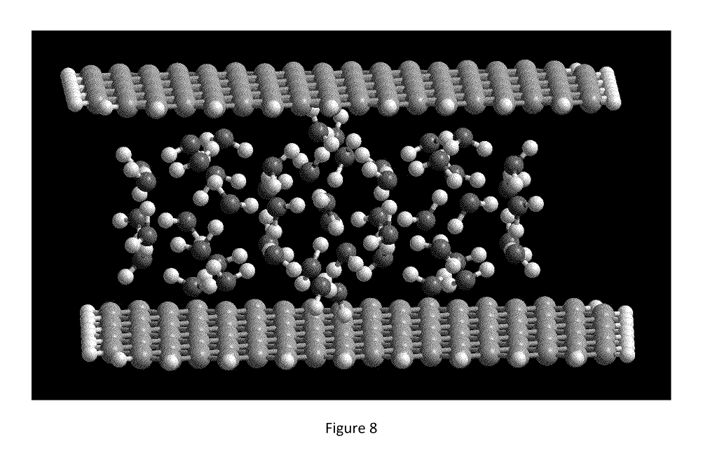

Pentagonal dodecahedral water structures (such as, for example, (H₂O)₂₀, (H₂O)₂₀⁺⁺, (H₂O)₂₀H⁺, and (H₂O)₂₁H⁺, and analogous structures including alcohol molecules) are particularly preferred for use in the practice of the present invention because, as shown in FIG. 7, delocalized pπ orbitals protrude from the dodecahedron vertices. Furthermore, Coulomb repulsion between like-charged dodecahedra can render pentagonal dodecahedral structures kinetically energetic. Also, the symmetry of the structure produces degenerate molecular orbitals that can couple with oxygen-oxygen vibrational modes in the far infrared to microwave regions, resulting in increased reactivity of the structure oxygen atoms. As discussed above, these modes can be induced through application of appropriate fields, or through the dynamical Jahn-Teller (“DJT”) effect.

It should be noted that pentagonal dodecahedral water structures had been produced and analyzed well before the development of the present invention. As early as 1973, researchers were reporting unexpected stabilities of water clusters of the form H^{|}(H₂O)₂₀ and H(H₂O)₂₁ (see, for example, Lin, Rev. Sci. Instrum. 44:516, 1973; Searcy et al., J. Chem. Phys. 61:5282, 1974; Holland et al., J. Chem. Phys. 72:11, 1980; Yang et al., J. Am. Chem. Soc. 111:6845, 1989; Wei et al., J. Chem. Phys. 94:3268, 1991). However, prior art analyses of these structures centered around discussions of hydrogen bond interactions, and struggled to explain their structure and energetics (see, for example, Laasonen et al., J. Phys. Chem. 98:10079, 1994). No prior art reference discussed the confinement of water clusters within nanotubes Moreover, no prior art reference recognized the desirability of inducing particular vibrational modes in these clusters.

### Nano-Environments

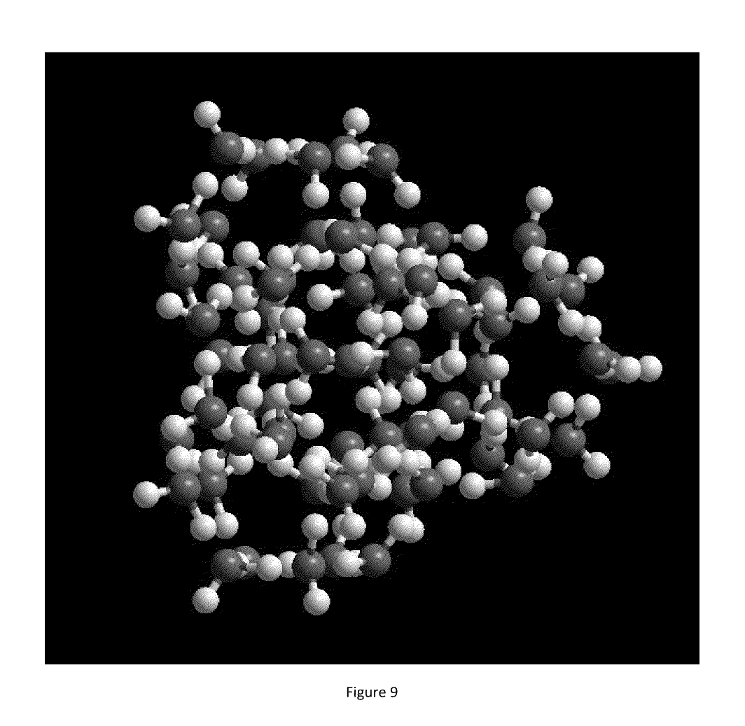

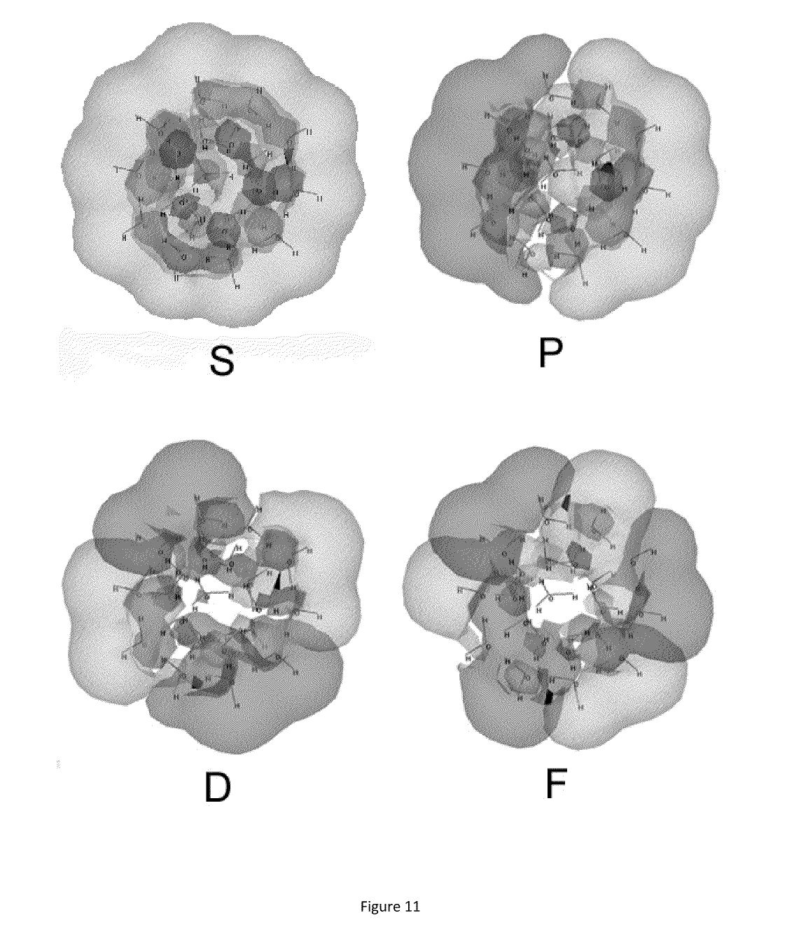

Nanotubes—those based mainly on carbon (FIG. 11) but also including metal oxides such as TiO₂—and graphene nano-layers, collectively nano-environments, (FIG. 8) provide a confining environment influencing and directing the formation of water clusters. Whereas other groups have focused solely on the nanotubes/graphene nano-layers themselves and the influences of external media such as liquid water and attached atoms or molecules on nanotube and graphene nano-layer properties, embodiments of the present invention are based on the properties of water clusters confined internally to nanotubes and graphene nano-layers and the influence of that nanowater on nanotube and graphene nano-layer's physical properties. First-principles quantum-chemistry calculations for water confined in carbon nanotubes and graphene nano-layers show stable water-nanocluster (“structured-water”) configurations and vibrational spectra like the ones shown for a nanotube in FIG. 7. Two primary bands of terahertz (THz) vibrational modes, corresponding respectively to low-THz-frequency oxygen surface vibrational modes and high-THz-frequency hydrogen librational modes, have been found. The unique low-frequency 0.5-5.6 THz water-cluster vibrational modes underlie nanofluidic flow and influence the electronic and other physical properties of the nanotubes and graphene nano-layers, whereas the higher-frequency band shown in FIG. 7 can be exploited in hydrogen-related chemical/electrochremical reactions, including those involving “heavy hydrogen” (deuterium) if ordinary water is replaced by heavy water.

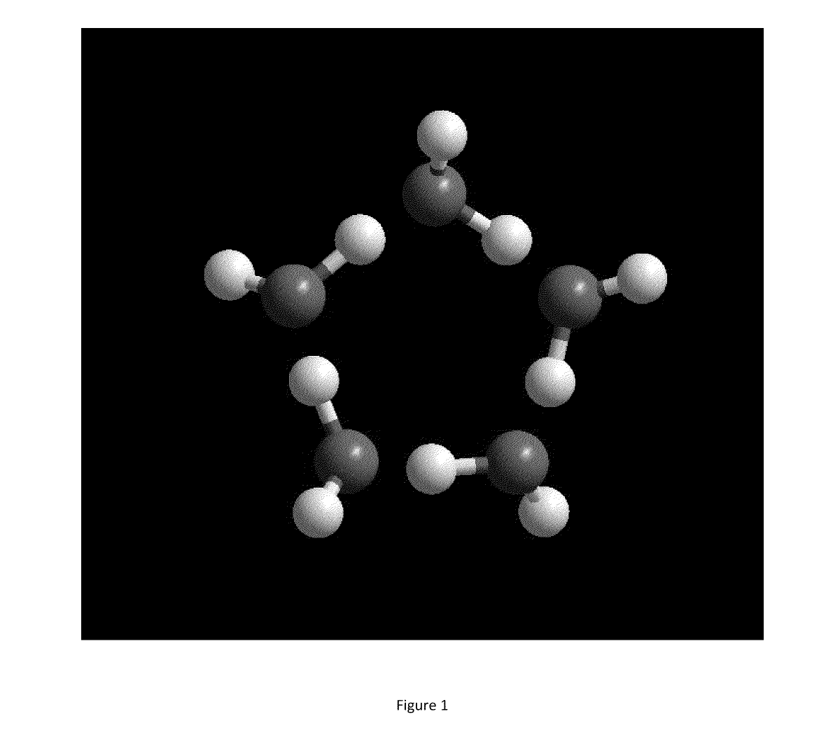

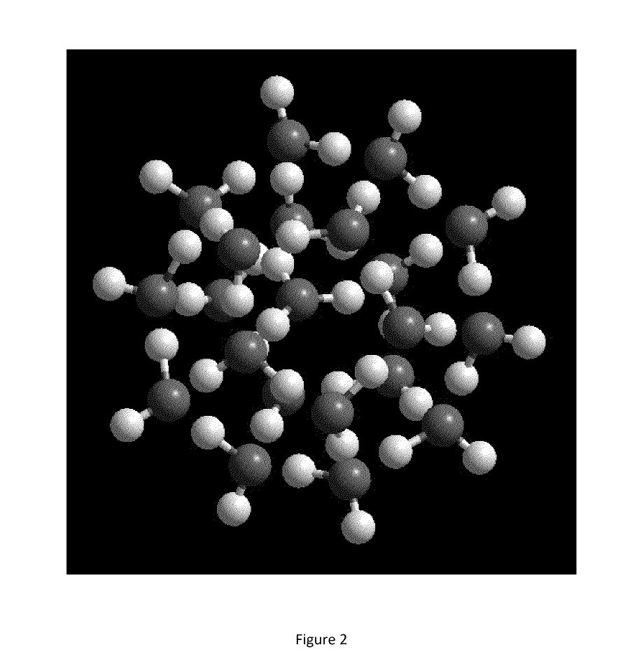

In some embodiments, the nano-environment includes a system that is a solid, liquid or gel phase. Preferred nanotube and graphene nano-layer confined water clusters of the present invention have high symmetry, preferably at least pentagonal symmetry (FIGS. 1 & 2). More generally, globular clusters containing up to 100 water molecules (FIG. 9) are preferred, although in some embodiments the water cluster may contain up to 300 water molecules. In some embodiments, the water clusters contain less than less than about 20 molecules. In some embodiments the water cluster has an average dimension (e.g., length, width, height, or diameter, depending on geometry) of less than about 100 nanometers, less than about 50 nanometers, less than about 10 nanometers, less than about 0.5 nanometers. In some embodiments, the water cluster has an average dimension in the range of about 0.5 nanometers to about 10 nanometers. These clusters form naturally in nanotubes, graphene nano-layers or in water-in-oil (W/O) nanoemulsions (prepared by methods described by the author in the prior art, U.S. Pat. Nos. 5,800,576 & 5,997,590, both of which are incorporated by reference).

Also, it is preferred that cluster vibrational modes such as that shown in FIG. 7 can be induced and further stimulated, either through application of an external electromagnetic field and/or through intrinsic action of the dynamical Jahn-Teller (DJT) effect, activated, for example, through the addition of electronic charge to the clusters. Water, uncharged or electrically charged and heavy or light water, is easily introduced into the nanotubes due to their capillary action. Such “confined” nano-environments automatically lead to water clustering and their resulting terahertz vibronic properties.

In some embodiments, the nano-environment may be doped with a variety of elements and alloys, with nitrogen, palladium, palladium-gold, palladium-silver preferred. In some embodiments, the nano-environment may be doped with an electron providing compounds. In some embodiments, the doping material is nitrogen, palladium, palladium-gold, or palladium-silver. In some embodiments the electron is provided to the water cluster. Additionally, in some embodiments, the water cluster confined in the nano-environment may be in the form of a nanoemulsion, as nanoemulsions are described in U.S. Pat. Nos. 5,800,576 & 5,997,590. In some embodiments the nano-emulsion includes a surfactant to aide in water cluster formation.

As is known, the Jahn-Teller (JT) effect causes highly symmetrical structures to distort or deform along symmetry-determined vibrational coordinates Qₛ (FIG. 14). Potential energy minima corresponding to the broken-symmetry forms then arise, and the structure can either settle into one of these minima (static Jahn-Teller effect) or can oscillate between or among such minima by vibrating along the relevant vibrational coordinates (the dynamical Jahn-Teller)

### THz Vibrations

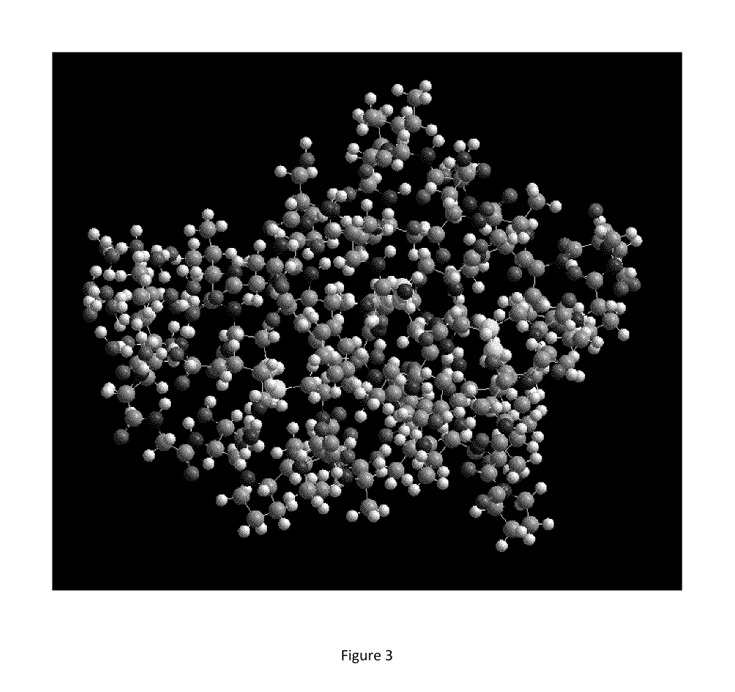

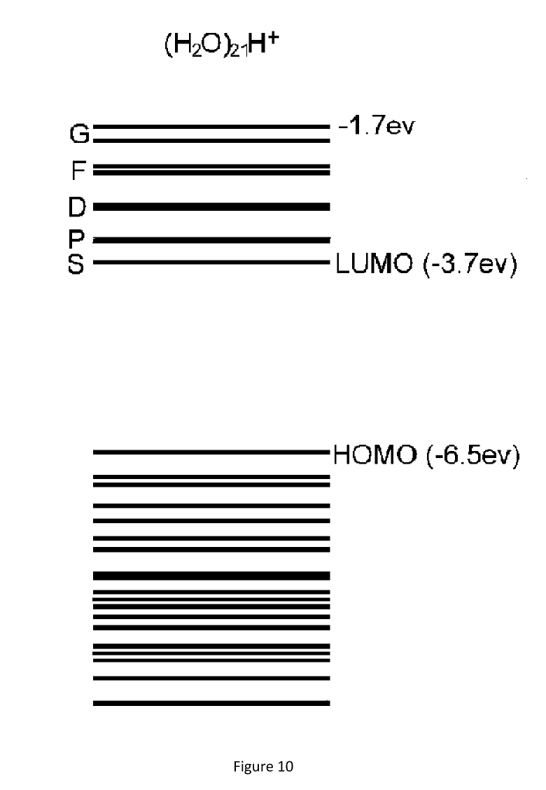

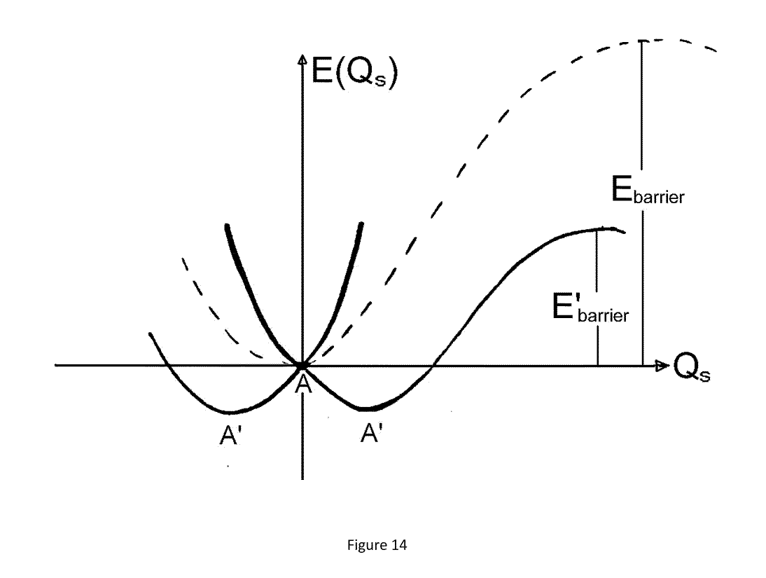

Density-functional molecular-orbital calculations for the archetype (H₂O)₂₁H⁺ cluster of FIG. 2 show the production of THz vibrations from water clusters. The molecular-orbital energies are shown in FIG. 10. The lowest unoccupied (LUMO) energy levels correspond to the huge, delocalized “S”-, “P”-,“D”- and “F”-like cluster wavefunctions mapped in FIG. 11. The S-like LUMO level is separated from the highest occupied (HOMO) level by an energy gap of nearly 3 eV. All the vibrational modes of the (H₂O)₂₁H⁻ cluster have also been computed for the first time, producing the complete spectrum shown in FIG. 12. Of particular interest is the lowest frequency manifold of cluster modes between 1.5 and 6 THz (50 to 200 cm⁻¹). The vectors in FIG. 13 show the 1.56 THz “squashing:” mode of the otherwise ideally symmetrical dodecahedral cluster (FIG. 6), with a large-amplitude vibration of the clathrated hydronium oxygen atom coupled to breathing vibrations of the cluster “surface” oxygen atoms. O—H “stretching” and “bending” vibrational modes are shown in FIG. 12 to occur at much higher frequencies spanning the broad infrared region of the spectrum. The most intense modes, i.e. those of largest vibrational amplitude, are localized high-infrared-frequency O—H bond stretches. The 1-6 THz manifold is uniquely due to water molecule clustering and is relatively less intense because of the delocalization of these (mainly oxygen) vibrations over the cluster surface. Density-functional calculations for larger water clusters such as that shown in FIG. 9, and even for the simple pentamer in FIG. 1, indicate similar manifolds of cluster terahertz vibrational modes between 1.5 and 6 THz. Although in some embodiments the frequency range can be from about 0.1 THz to about 32 THz.

Anomalous emission and absorption of far-infrared and submillimeter (THz) radiation from the atmosphere were first identified by Gebbie as possibly associated with aerosols of water clusters undergoing solar optical pumping. He argued that at sea-level densities such aerosols are separated by 10⁴ times their cluster radii and, under this condition of isolation, can be pumped by photons into vibrational modes of lowest frequency analogous to a Bose-Einstein condensation, thus acquiring giant electric dipoles. Their interaction with radiation is thereby greatly enhanced. For example, in some embodiments, atmospheric aerosol absorption at 50 cm⁻¹ is comparable with that of a water molecule rotation line at 47 cm⁻¹, which has a dipole moment of 1.85 Debyes in an air sample containing 10¹⁷ cm⁻³ water molecules. Even if the aerosol density of water clusters is only approximately 10⁴ cm⁻³, then an effective aerosol transition moment of 10⁶ Debyes can be inferred. In other words, this greatly enhanced submillimeter (THz) absorption and emission from comparatively low-density aerosols can be attributed to solar optical pumping, cooperative stimulated emission, and maser action of the constituent water clusters.

The electronic structure (FIGS. 10 & 11) and vibrational spectrum (FIG. 12) of the (H₂O)₂₁H⁺ (and similar) clusters satisfy the conditions for intense optical absorption and THz emission. First, the near-ultraviolet optical pumping of an electron from the HOMO to LUMO puts the electron into the bound S-like cluster molecular orbital mapped in FIG. 11. This is a stable excited state of the cluster. Near-infrared absorption can then excite the LUMO S-like electron to the nearby unoccupied P-like orbital (FIGS. 10 and 11). Actually, there are three nearly degenerate P-like cluster molecular orbitals, analogous to the degenerate pₓ, p_{y}, and p_{z} orbitals of an atom. Unlike an atom, however, the Pₓ, P_{y}, P^{z} near-degeneracy in the water cluster subjects it to the dynamic Jahn-Teller (DJT) effect, where the cluster attempts to remove the degeneracy and lower its energy through vibronic coupling and symmetry breaking. Near-infrared promotion of the optically pumped electron between the closely spaced P-like and D-like cluster energy levels (FIG. 10) is also likely. Even in the absence of DJT coupling, excitations within the LUMO manifold can decay vibronically due to the mixing of electronic states. The vibrations here are the THz modes that are the lowest-frequency (H₂O)₂₁H⁺ cluster modes, like the 1.56 THz “squashing mode” shown in FIGS. 13 and 6. The predicted electric dipole moment of the (H₂O)₂₁H⁺ cluster in its optically pumped state is nearly 10 Debyes, as compared with the 1.85 Debye moment for a single water molecule. As shown by the vectors in FIG. 13, the large-amplitude THz vibration of the clathrated hydronium oxygen atom, coupled to breathing modes of the cluster “surface” oxygen atoms, produces an oscillating large electric dipole moment that constitutes the transition moment for THz emission when the cluster is optically pumped. The excited electron in the LUMO manifold is weakly bound compared to the cluster hydrogen-bonded “valence” electrons below the LUMO level. In fact, the occupied cluster molecular orbital levels below the HOMO (FIG. 10) are analogous to the “valence band” of a semiconductor, whereas the LUMO manifold is analogous to a semiconductor “conduction band”. Thus in an aerosol of (H₂O)₂₁H⁻ (or similar) clusters, the ensemble of optically pumped electrons in the LUMO manifolds, loosely bound to the vibrationally activated, positively charged (H₂O)₂₁H⁺ molecular ion “cores”, effectively constitutes a “plasma”. An alternative scenario is to view an electron in the LUMO manifold “conduction band”, responsible for the large dipole moment of the clusters, as oscillating in the reference frame of the (H₂O)₂₁H⁺ ion core. Since the positive charge of the (H₂O)₂₁H⁻ cluster is due to the “extra” proton, an even simpler picture is a “hydrogenic plasma” model, in which the aerosol is modeled as electrons loosely bound to protons in large-radius “Rydberg-like” S-, P-, D- or F-like orbits.

The present invention provides the recognition that DJT-induced vibrational oscillations in certain water clusters can significantly lower the energy barrier for chemical reactions involving such clusters (FIG. 14). Specifically, the present invention teaches that water clusters (or aggregates thereof) having a ground-state electronic structure characterized by a manifold of fully occupied molecular orbitals (HOMO) separated from a manifold of unoccupied molecular orbitals (LUMO) by an energy gap (FIG. 10) can be made to have enhanced reactivity characteristics if the degenerate LUMO states (FIG. 11) are occupied via HOMO-to-LUMO electromagnetic (optical) excitation or through the external addition of electronic charge, leading to a prescribed distortive symmetry breaking and DJT-induced vibronic oscillations.

Finally, as pointed out above, the large-amplitude THz vibration of the clathrated hydronium oxygen atom, coupled to breathing modes of the cluster “surface” oxygen atoms (FIG. 13), produces an oscillating large electric dipole moment that constitutes the transition moment for THz emission when the cluster is optically pumped. Thus water vapor populated by such water clusters should be strong sources of terahertz radiation between approximately 1.5 and 6 THz (FIG. 12). To estimate the THz emission power of a water cluster at 1.5 THz, we begin with the standard formula for electromagnetic radiation power emission from an oscillating electric dipole (in cgs units), P=p²ω⁴/3c³, where p is the dipole moment, ω is the (angular) frequency of the dipole vibration—in a protonated water cluster (FIG. 2) the “squashing vibration shown in FIG. 13—and c is the velocity of light. The dipole moment of the protonated cluster (H2O)₂₁H⁻ in its ground state is approximately 10 Debyes (1 Debye=10⁻¹⁸ esu-cm). Under electromagnetic (optical) excitation across the HOMO-LUMO energy gap of such a cluster or by external addition of electrons to the LUMOs (FIG. 10), p can approach 50 D, i.e. the effective dipole moment of an optically pumped or negatively-charged water cluster is much larger than that of the ground state. Therefore at THz frequencies, e.g. 1.5 THz, the emission power output of a single water cluster is typically of the order of (converting cgs to MKS units) 10⁻²¹ watt/cluster. For a room-temperature, 40 ton pressure density of 10¹² water clusters/cm³, this yields a potential THz emission power of approximately 10⁻⁹ watt or a nanowatt/cm³. Therefore a one cubic meter water-vapor chamber containing such a density of water clusters should potentially produce a milliwatt of THz radiation, i.e. comparable to that produced by a commercially available semiconductor THz source. Raising the pressure of the chamber should significantly increase the water cluster population, approaching 10¹⁵/cm³ at 100 torr. This would imply 10⁻⁶ watt/cm³ or a microwatt/cm³—or one watt/m³, which exceeds the power output of most commercially available THz sources.

We claim:

1. A method comprising:
providing a nano-environment; and
confining heavy or light water in the nano-environment such that at least one water cluster forms.

2. The method of claim 1 wherein the providing step provides a nano-environment that comprises systems in solid, liquid, or gel phases and/in contact with macromolecules.

3. The method of claim 1 wherein the providing step provides a nano-environment that comprises a nanotube.

4. The method of claim 1 wherein the providing step provides a nano-environment that comprises a nano-layer.

5. The method of claim 3 wherein the providing step provides a nano-environment that comprises a carbon nanotube.

6. The method of claim 1 wherein the providing step provides a nano-environment that comprises a graphene nano-layer.

7. The method of any of claims 2-6 wherein the providing step provides a nano-environment that is doped with an electron donating compound.

8. The method of claim 7 wherein the providing step provides a nano-environment that is doped with a variety of elements and alloys.

9. The method of claim 8 wherein the providing steps provides a nano-environment that is doped with a material selected from the group consisting of nitrogen, palladium, palladium-gold, palladium-silver and combinations thereof.

10. The method of claim 1 wherein the confining step produces a water cluster that comprises at least one pentagonal water cluster.

11. The method of claim 1 wherein the confining step produces a water cluster that comprises at least one pentagonal-dodecahedral water cluster.

12. The method of claim 1 wherein the confining step produces a water cluster that comprises at least one water cluster with at least partial pentagonal-dodecahedral symmetry.

13. The method of claim 1 wherein the confining step produces a water cluster that comprises less than about 300 molecules.

14. The method of claim 1 wherein the confining step produces a water cluster that comprises less than about 100 molecules.

15. The method of claim 1 wherein the confining step produces a water cluster that comprises less than about 20 molecules.

16. The method of claim 1 wherein the confining step produces a water cluster that has an average dimension of about less than about 100 nanometers.

17. The method of claim 1 wherein the confining step produces a water cluster that has an average dimension of about less than about 50 nanometers.

18. The method of claim 1 wherein the confining step produces a water cluster that has an average dimension of about less than about 10 nanometers.

19. The method of claim 1 wherein the confining step produces a water cluster that has an average dimension in the range of about 0.5 nanometers to about 10 nanometers.

20. The method of claim 1 wherein the confining step produces a water cluster that has molecular vibrations in the frequency range of about 0.1 terahertz to about 32 terahertz.

21. The method of claim 1 wherein the confining step produces a water cluster that has an electronic structure where the cluster LUMOs are “Rydberg” “S”-, “P”-, “D”-, and “F”-like molecular orbitals that accept an extra electron via optical excitation, ionization, or electron-donation from interacting atoms or molecules.

22. The method of claim 1 wherein the confining step produces a water cluster in which its terahertz molecular vibrations couple with its electronic structure to create terahertz vibronic properties.

23. The method of claim 22 further comprising stimulating the water cluster's terahertz vibronic properties by the dynamic Jahn-Teller effect.

24. The method of claim 22 further comprising stimulating the water cluster's terahertz vibronic properties by optical excitation.

25. The method of claim 22 further comprising stimulating the water cluster's terahertz vibronic properties by applying an electromagnetic field.

26. The method of claim 22 further comprising stimulating the water cluster's terahertz vibronic properties by applying an electrical charge.

27. The method of claim 22 wherein the cluster's terahertz vibronic properties are further stimulated by doped electron-donating compounds in the nano-environment.

28. The method of claim 22 wherein the confining step includes a water cluster in an water-in-oil nanoemulsion.

29. The method of claim 28 wherein the confining step produces a nanoemulsion further comprises a surfactant.

30. The method of claim 28 wherein the confining step produces a nanoemulsion further comprises an electron donating compound.

31. The method of claim 22 further comprising stimulating the water cluster's terahertz vibronic properties by introducing an electron donating compound.

32. A composition comprising water confined in a nano-environment such that at least one water cluster forms.

33. The composition of claim 32 wherein the nano-environment comprises systems in solid, liquid, or gel phases and in contact with macromolecules.

34. The composition of claim 32 wherein the nano-environment comprises a nanotube.

35. The composition of claim 31 wherein the nano-environment comprises a nano-layer or nano-layers.

36. The composition of claim 32 wherein the nano-environment comprises a carbon nanotube.

37. The composition of claim 32 wherein the nano-environment comprises a graphene nano-layer.

38. The composition of any of claims 33-37 wherein the nano-environment is doped with an electron donating compound.

39. The composition of claim 32 wherein the water cluster comprises at least one pentagonal water cluster.

40. The composition of claim 32 wherein the water cluster comprises at least one pentagonal-dodecahedral water cluster.

41. The composition of claim 32 wherein the water cluster comprises at least one water cluster with at least partial pentagonal-dodecahedral symmetry.

42. The composition of claim 32 wherein the water cluster comprises less than about 300 molecules.

43. The composition of claim 32 wherein the water cluster comprises less than about 100 molecules.

44. The composition of claim 32 wherein the water cluster comprises less than about 20 molecules.

45. The composition of claim 32 wherein the water cluster have an average dimension of about less than about 100 nanometers.

46. The composition of claim 32 wherein the water cluster have an average dimension of about less than about 50 nanometers.

47. The composition of claim 32 wherein the water cluster have an average dimension of about less than about 10 nanometers.

48. The composition of claim 32 wherein the water cluster have an average dimension in the range of about 0.5 nanometers to about 10 nanometers.

49. The composition of claim 32 wherein the water cluster has molecular vibrations in the frequency of 0.1 terahertz to 32 terahertz.

50. The composition of claim 32 wherein the water cluster has an electronic structure where the cluster LUMOs are “Rydberg” “S”-, “P”-, “D”-, and “F”-like molecular orbitals that accept an extra electron via optical excitation, ionization, or electron-donation from interacting atoms or molecules.

51. The composition of claim 32 wherein the water cluster's terahertz molecular vibrations couples with its electronic structure to create terahertz vibronic properties.

52. The composition of claim 50 wherein the water cluster's terahertz vibronic properties are further stimulated by the dynamic Jahn-Teller effect.

53. The composition of claim 50 wherein the water cluster's terahertz vibronic properties are further stimulated by optical excitation.

54. The composition of claim 50 wherein the water cluster's terahertz vibronic properties are further stimulated by applying an electromagnetic field.

55. The composition of claim 50 wherein the water cluster's terahertz vibronic properties are further stimulated by applying an electrical charge.

56. The composition of claim 50 wherein the water cluster's terahertz vibronic properties are further stimulated by doped electron-donating compounds in the nano-environment.

57. The composition of claim 32 wherein the water cluster is in a water-in-oil nanoemulsion.

58. The composition of claim 57 wherein the nanoemulsion further comprises a surfactant.

59. The composition of claim 57 wherein the nanoemulsion further comprises an electron donating compound.

60. The composition of claim 50 wherein the cluster's terahertz vibronic properties are further stimulated by an electron from an electron donating compound.
